(19) United States
(12) Patent Application Publication
(10) Pub. No.: US 2008/0235087 A1
(43) Pub. Date: Sep. 25, 2008

(54) System and method for presenting alternative advertising data

(75) Inventors: Brian S. Amento, Morris Plains, NJ (US); Christopher Harrison, Mount Kitto, NY (US); Larry Stead, Upper Montciair, NJ (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures L.P., Reno, NV (US)

(21) Appl. No.: 11/725,992

(22) Filed: Mar. 20, 2007

(51) Int. Cl. G06Q 30/00

(52) U.S. Cl. 705/14

(57) ABSTRACT

A computerized method for presenting an alternative advertising data item is disclosed. In one embodiment the method includes receiving a primary advertising data item in a video data stream in an internet protocol television (IPTV) system; replacing a generic data of the primary advertising data item with alternative data to create the alternative advertising data item; and sending the alternative advertising data item to an end user device for presentation of the alternative advertising data item in place of the primary advertising data item upon occurrence of an end user event. A system is disclosed for performing the method. A data structure is disclosed for containing data embedded in a computer readable medium for providing a functional and structural interrelationship between a processor, the data structure and data stored in the data structure.

### FIELD OF THE DISCLOSURE

The present disclosure generally relates to the field of presenting alternate advertising data in place of primary advertising data.

### BACKGROUND OF THE DISCLOSURE

The introduction of Digital Video Recorders (DVRs) has revolutionized the television recording industry. DVRs store program material onto a storage medium that is easily accessible, reusable, and the recording does not degrade over time as with videotapes. DVRs give the viewer an unprecedented amount of control over how the viewer watches live and recorded television programs. One of the effects of the DVRs is that as viewers watch television programs stored on the DVRs' storage medium, they have a tendency to skip over the commercial breaks. Television broadcasters and advertisers have a negative viewpoint of the advent of the DVR. The feeling is that the DVR is destroying any purpose of advertising on the broadcast medium. Primetime no longer exists because viewers are not tied to the broadcaster's schedule. DVRs allow the viewer to easily store all of his desired programs for later viewing. Broadcasters generate their revenue through the value of the commercial spots. Advertisers feel that they are losing their potential viewership “eyes.” If advertisers do not believe that there is any value in a primetime commercial spot, then the broadcasters lose large proportions of their revenue.

### BRIEF DESCRIPTION OF THE DRAWINGS

FIG. 1 depicts an illustrative embodiment of a system for presenting alternative advertising data;

FIG. 2 depicts a flow chart of functions performed in a method for presenting alternative advertising data;

FIG. 3 depicts a data structure embedded in a computer readable medium that is used by a processor and method for presenting alternative advertising data; and

FIG. 4 is an illustrative embodiment of a machine for performing functions disclosed in an illustrative embodiment.

### DETAILED DESCRIPTION

In one particular illustrative embodiment, a computerized method is disclosed for replacing a primary advertising data item with an alternative advertising data item, the method including but not limited to receiving a primary advertising data item in a video data stream; replacing a generic data subset of the primary advertising data item with alternative data to create the alternative advertising data item; and sending the alternative advertising data item to an end user device for presentation of the alternative advertising data item in place of the primary advertising data item upon occurrence of an end user event. The terms “data” is used herein to describe an aggregation of data and the term “data item” is used to describe a subset of the aggregation of data. Thus a group of data items is collectively referred to as data. A generic data subset of the primary advertising data item is used to indicate that only a portion of a particular advertising data type is identified as generic data and replaced with alternative data. Thus, for example, in a particular illustrative embodiment, in an audio track in a primary advertising data item, only a word or phrase would be identified as generic data and replaced with alternative data.

In another particular illustrative embodiment the video data stream comes from an internet protocol television (IPTV) system, the method further including but not limited to sensing the generic data in the primary advertising data item; and marking the generic data in the primary advertising data item. In another particular illustrative embodiment the end user event is a personal video recorder trick play command selected from the group consisting of fast forward and commercial skipping. In another particular illustrative embodiment the generic data further comprises generic audio key words provided by an IPTV advertising server and the alternative data item further comprises alternative audio words provided by the IPTV advertising server.

In another particular illustrative embodiment the generic data is of a first data type selected from the group consisting of audio, video, text and image data and the alternative data further is of a data type selected from the group consisting of audio, video, text and image data, wherein the generic data of the first data type is replaced by the alternative data of the first data type. In another particular illustrative embodiment sensing the generic data further comprises sensing a generic data marker in the primary advertising data item, wherein the generic data marker is inserted by an upstream data sensing system at a server in the IPTV system.

In another particular illustrative embodiment the generic data is sensed at an IPTV server by an upstream data sensing system and the generic data is replaced with the alternative data at an end user device by an end user data sensing system. In another particular illustrative embodiment the alternative data further comprises a plurality of alternative data items for each of a plurality of generic data wherein one of the plurality of choices of alternative data items is selected for replacing the generic data based on an end user profile. In another particular illustrative embodiment the end user event comprises skipping from a first primary advertising data item to a second primary advertising data item in the video data stream.

In another particular illustrative embodiment duration for the alternative advertising item is based on an average duration of completing the trick play command by the end user for duration of the primary advertising data item, based on an end user profile for the end user. In another particular illustrative embodiment duration of the alternative advertising data item is based on duration of the primary advertising data item and end user opt-in data in an end user profile for the end user, wherein the opt-in data indicates that the end user is presented the alternative advertising data item.

In another particular illustrative embodiment the alternative advertising data item further comprises a plurality of alternative advertising data items, wherein an end user skips forward and backward between each of the plurality of alternative advertising data items upon the presentation at the end user device.

In another particular illustrative embodiment system is disclosed for presenting an alternative advertising data item, the system including but not limited to a computer program comprising computer instructions stored in a computer readable medium; and a processor in data communication with the computer readable medium for executing the computer instructions, the processor further comprising, a first interface for receiving a primary advertising data item in a video data stream, a second interface for receiving a generic data subset of the primary advertising data item, the computer program further comprising instructions to replace the generic data in the primary advertising data item with alternative data to create an alternative advertising data item and instructions to send the alternative advertising data item to an end user device for presenting the alternative advertising data item in place of the primary advertising data item upon occurrence of an end user event.

In another particular illustrative embodiment of an illustrative system, the video data stream comes from an internet protocol television (IPTV) system, the computer program further comprising instructions to sense the generic data in the primary advertising data item; and instruction to mark the generic data in the primary advertising data item. In another particular illustrative embodiment of an illustrative system, the end user event is a personal video recorder trick play command selected from the group consisting of fast forward and commercial skipping. In another particular illustrative embodiment of an illustrative system, the generic data further comprises generic audio key words provided by an IPTV advertising server and the alternative data item further comprises alternative audio words provided by the IPTV advertising server, wherein a generic audio word is replaced by an alternative audio word based on an end user profile.

In another particular illustrative embodiment of an illustrative system, the end user event is a personal video recorder trick play command selected from the group consisting of fast forward and commercial skipping. In another particular illustrative embodiment of an illustrative system, duration for the alternative advertising item is based on an average duration of completing the trick play command by the end user for duration of the primary advertising data item based on an end user profile for the end user. In another particular illustrative embodiment of an illustrative system, the alternative advertising data item further comprises a plurality of alternative advertising data items, wherein an end user skips forward and backward between each of the plurality of alternative advertising data items, upon presentation at the end user device.

In another particular illustrative embodiment of an illustrative system, computer readable medium having stored therein a computer program, the computer program comprising computer instructions useful for presenting an alternative advertising data item in place of a primary advertising data item, the computer program comprising instructions to receive the primary advertising data item in a video data stream in an internet protocol television (IPTV) system; instructions to receive generic data for sensing the generic data in the primary advertising data item; instructions to sense a generic data subset of the primary advertising data item; instructions to replace the generic data in the primary advertising data item with alternative data to create the alternative advertising data item; and instructions to send the alternative advertising data item to an end user device display for presenting the alternative advertising data item in place of the primary advertising data item upon occurrence of an end user event. In another particular illustrative embodiment of an illustrative medium, in the computer program the generic data is of a first data type selected from the group consisting of audio, video, text and image data and the alternative data further is of a data type selected from the group consisting of audio, video, text and image data, wherein the generic data of the first data type is replaced by the alternative data of the first data type.

In another particular illustrative embodiment a computer program computer readable medium is disclosed having a data structure embedded thereon, the data structure including but not limited to a first field for storing data indicating generic advertising data for sensing a subset of a primary advertising data item; and a second field for storing data indicating a plurality of alternative audio advertising data words for replacing the audio key word generic data in the primary advertising data item based on an end user profile data. In another particular illustrative embodiment of an illustrative medium, in the data structure the end user profile data contains data selected from the group consisting of location data and demographic data for use in selecting one of the plurality of alternative audio advertising data words for replacing the audio key word generic data.

In another particular illustrative embodiment of an illustrative medium, in the computer program the data structure further includes but is not limited to a third field for storing data indicating markers for the generic data for use in replacing the generic data. In another particular illustrative embodiment of an illustrative medium, in the computer program the data structure further comprising a fourth field for storing data indicating an average duration for an end user to complete a trick play command for a duration of the primary advertising data item. In another particular illustrative embodiment of an illustrative medium, in the computer program the data structure further includes but is not limited to a fifth field for storing data indicating alternative advertising data items for replacement of primary advertising data items for the duration of the average duration. In another particular illustrative embodiment of an illustrative medium, in the computer program the data structure further includes but is not limited to a sixth field for storing data indicating an opt-in for presentation of alternative rapid advertising data.

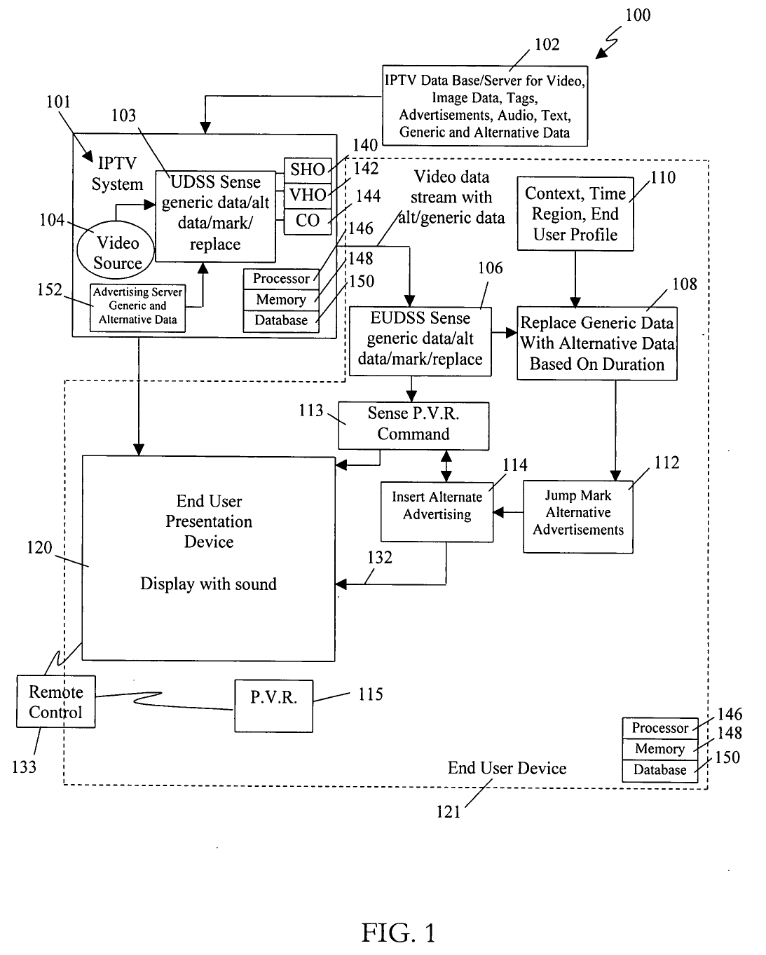

Turning now to FIG. 1, FIG. 1 shows an illustrative embodiment of a television signal delivery system 100, including but not limited to an internet protocol television (IPTV) system 101 and an end user device 121 for receiving primary and alternative advertising data items and presenting the primary and alternative advertising data items. The IPTV system includes a hierarchically arranged network of IPTV servers that form a digital IPTV network. The IPTV network streams internet protocol (IP) video data including primary and alternative advertising data items and generic data and alternative data from a super head end (SHO) server 140, video head end (VHO) server 142, or central office (CO) server 144 to a end user device. The IPTV system 101 includes but is not limited to an upstream data sensing system (UDSS) 103. The end user device 121 includes but is not limited to an end user data sensing system (EUDSS) 106. Thus, the IPTV system comprises a hierarchical network of servers (SHO, VHO, CO) that hierarchically distribute video data streams including individual commercials, referred to herein as advertising data items and generic data and alternative data. The hierarchical ITPV network distributes the video data hierarchically to smaller geographic regions (SHO to VHO to CO to end user, respectively) and finally to an end user device 121 such as a set top box device (STB).

The primary and alternative advertising data includes audio, text video and images that are displayed on an end user presentation device 120, which includes a display and sound reproduction system, such as a loudspeaker or piezoelectric device. The SHO server delivers national video data (including image, video, text and audio data) content in the form of a television signal (e.g., an IPTV digital video data stream) to regional VHO server, which redistributes the video data stream to sub regional CO servers. Each SHO, VHO, CO and end user device 121 contains an advertising/video data server having a processor 146, computer readable medium collectively referred to as memory 148 and database 150. The UDSS 103 and EUDSS 106 sense generic data in the video data stream television signal having different data types.

The EUDSS and UDSS compares the video data stream that makes up the television signal data to a generic data list to sense the generic data in the television signal. In a particular illustrative embodiment a UDSS then marks the generic data with a generic data marker for replacement with alternative data at a down stream EUDSS. In another particular illustrative embodiment, the EUDSS replaces the generic data with alternative data. In one particular embodiment, when generic data is sensed in the video data stream by the UDSS, the generic data is marked for later recognition by the EUDSS at the end user device. This marking of generic data allows a lower processing power EUDSS to be installed at the end user device for sensing of the markers for replacing marked generic data. A video source 104 provides the video data stream which originates in the IPTV system. The advertising data items, including but not limited to alternative advertising data items generic data list and alternative data list is provided by the advertising server 152 or IPTV data base 102. The alternative and generic advertising data items, weighting data can be included in meta data portions of the incoming MPEG video data stream.

Generic data is sensed by the UDSS 103 is sensed at the EUDSS by comparing the video data stream to a list of generic data items at the UDSS or to a list generic data items sent to each end user device. Thus different end users may receive different lists of generic and alternative data items and therefore sense different generic data to be replaced by different alternative data at each of their respective EUDSS's. The UDSS and EUDSS each have access to a list of alternative data items to replace sensed generic data items in the video data stream. Each list of generic data items and alternative data items can contain different demographic data or regional data such as images, text or audio data related to a specific region. Thus each end user can sense different geographic or regional generic data in the video data stream based on their list of generic data items and weighting data for generic and alternative data items sent to an end user device with which they are associated. In a particular embodiment a group of end users may receive the same list of generic data but different lists of alternative data based on their demographics or location as shown in an end user profile for the end user. The lists of generic data items, alternative data items and weighting data are stored in a data structure or database embedded in a computer readable medium accessible to a processor at the IPTV server or end user device.

The generic data sensed in the television signal or IPTV video data stream may be of different data types, including but not limited to video data, image data, text data and audio data. The generic data is replaced with alternative data having the same data type. The EUDSS 106 senses or recognizes generic data including but not limited to video data, image data, text data and audio data in the television signal or video data stream to generate keywords from the combination of the images, audio and text data sensed in the incoming video signal. In a particular illustrative embodiment, the incoming television signal is a digital video data stream, delivered from an IPTV system network of servers. In another particular illustrative embodiment, the television signal is a digital television video signal delivered over a broadcast cable system. In another particular illustrative embodiment, the television signal is an analog television signal delivered over a radio frequency antenna. In another particular illustrative embodiment, generic data including but not limited to video data, image data, text data, audio data are sensed in the video data stream television signal by the EUDSS in the IPTV system.

The weighting data can be inserted into the television signal, e.g., using meta data in an MPEG video data stream or sent separately to an end user device. The weighting data is used to weight data types, regional alternative data and viewer or demographic tendency to respond to a data type. The generic data can be sensed by a EUDSS 106 at an end user device 121 such as a set top box. In another particular embodiment, the end user device is a mobile internet protocol (IP) device including but not limited to a cell phone, personal data assistant or a web tablet. The generic data is compared to video, audio, image and text data in the incoming television signal to select generic data to replace with alternative data.

Alternative data weighting data is used to weight alternative data according to the data type, geographic region, demographic (location, age, language, income, gender, purchase history etc.) and according to a tendency to respond to a particular data type of an end user or an end user's demographic. Each end user's response to a particular data type is recorded and stored at the end user device. A tendency for each user to respond to a data type is determined from the recorded responses and used to determine a tendency of an end user to respond to the data type. Weights are assigned to data types based on the user's response tendency each data type (image, video, audio, text). These tendencies are reported to the IPTV system servers for use by advertisers in directing targeted advertising to the end user and the end user's demographic group. Thus, weighting data for each end user and end user demographic group can be stored at the IPTV server and used to distribute weighting data to demographic groups of end users and individual end users. Additional criteria stored in an end user profile, including but not limited to internet purchasing history, internet surfing activity, etc. can be used to weight generic and alternative data. Data weighted more heavily is favored over data with less weight.

In a particular illustrative embodiment the weighting data that may be included is a set of weights assigning data type weights, response tendency weights, viewer profile weights, or regional weights. In another particular embodiment the weighting data includes weighted reference data, which is used to favor selection of the alternative data for replacement of generic data sensed by the EUDSS or UDSS. Thus the weighted alternative data will be favored or weighted more heavily than other alternative data. For example if a particular end user or a demographic for a particular end user has a tendency to respond more to text data than audio data, then sensed generic text data will be weighted more heavily than sensed generic audio data. Regional weighted alternative data can be sent to favor different alternative data in different regions. Thus the same alternative data list can be sent to different regions and the weighting data can be used to favor different alternative data in different regions. In another alternative embodiment, the weighting data can be altered by an end user profile. In another illustrative embodiment, different alternative data can be sent to different regions or different end users. In another illustrative embodiment, an end user profile can be used to select alternative data for replacing generic data.

Similarly, if an end user is in a particular demographic group with a known response to particular data types or a particular end user has a tendency to respond more to video or image data than text data, then alternative data for the sensed generic video or image data will be weighted more heavily than sensed text data for the particular end user or demographic group of end users. In another particular illustrative embodiment, each end user device receives the same list of generic data and a different list of alternative data based on their end user profile. The alternative data may include names of businesses near the end user device location, names of foods or celebrities that appeal to a demographic group with which the end user is associated based on the data stored in the end user profile stating location and demographic group for the end user.

Generic and alternative data can be supplied to the UDSS 103 or the EUDSS 106 by an advertising server 152 from the IPTV system general reference data database 103 or by an advertiser reference data database 102. The generic and alternative advertising lists can contain video data, image data, audio data, text data, data tags and advertising data which can be used for replacement of primary advertising data with alternative advertising data for presentation on an end user device. An advertiser or other user can sense generic data in the video data stream using UDSS 103 to select generic data in advertising data appearing in the video data stream to insert alternative data in place of the generic in the video data stream. The generic data can also be marked by the UDSS so that less processing power is required to sense generic data at the EUDSS, since the EUDSS would only have to look for generic data markers indicating generic data (video, audio, text, image) rather that performing full sensing (video, audio, text, image) including but not limited to speech recognition, pattern recognition, and image recognition.

The advertiser or user can select regions, data types and demographics by selecting weighting data or weighted alternative data for insertion into the television signal or downloading to an end user device from the IPTV network SHO, VHO or CO. Each generic and alternative data item can have a particular weight assigned in the database and can be used to weight sensing of the generic and alternative data items. Keywords for video and audio comprise image or video data for company logos or products or blank areas in an image or video scene suitable for filling with alternative image or video data. Keywords such as audio or text phrases associated with generic data items or alternative data items can be weighted by the particular weights for selecting appropriate alternative data for replacing the generic data items. The weighting data for the generic and alternative data items can be included in the video data stream meta data or in a separate download to the end user device and stored in memory in a data structure or database embedded in a computer readable medium.

In an illustrative embodiment the data sensing devices UDSS and EUDSS sense or recognize generic data items from the generic data in the video data stream. Generic data items can have different data types, including but not limited to, video, image, text and audio data types for replacement with an appropriate alternative data item having the same data type as the generic data item which it replaces. The sensed generic data item can be replaced at the IPTV server or marked for replacement and sent to the EUDSS where the generic data is replaced with appropriate alternative data. The audio and text passages included generic words that are identified using speech recognition and text recognition techniques. A default weighting data for data type weight is assigned on a scale of 10, for audio data=7, video/image data=5, and text data=3. Those weights can be adjusted by weighting the reference data downloaded to the end user device. Additional weight is assigned to keywords (e.g., football, Corvette, Wild at Heart) in the same category (e.g., sports, politics, cars, movies, etc.) appearing in more than one data type at substantially the same time (e.g., within 2 seconds). Thus if the image of a football and the phase “football team” which are in the same category, i.e., sports, are sensed in the television signal at the same or close to the same time, additional weight is assigned to the generic phrase “football team.”

The keywords can also be weighted by the context, which includes time of day, geographic region and current viewer profile, response tendency, demographic, which is provided by system 110. Thus the alternative data item (audio, image, text or video) for “foot ball team”, i.e., “Dallas Cowboys” can be assigned more weight in Texas than Washington, D.C. A different alternative data item for football team, i.e., “Washington Redskins” can be assigned more weight in Washington, D.C. The keywords, which are weighted according to the inputs in block 108, are sent to system 112 where the alternative data are weighted.

In an illustrative embodiment the EUDSS 106 takes input from an end user remote control 133 to store selected advertising data extracted from the video data stream. The EUDSS also senses reference data in the stored advertising data. The key words include image, text, audio and video data. A context is recorded in system function block 110 wherein the processor records time of day, viewer profile, program viewed and region associated with the selected advertising data.

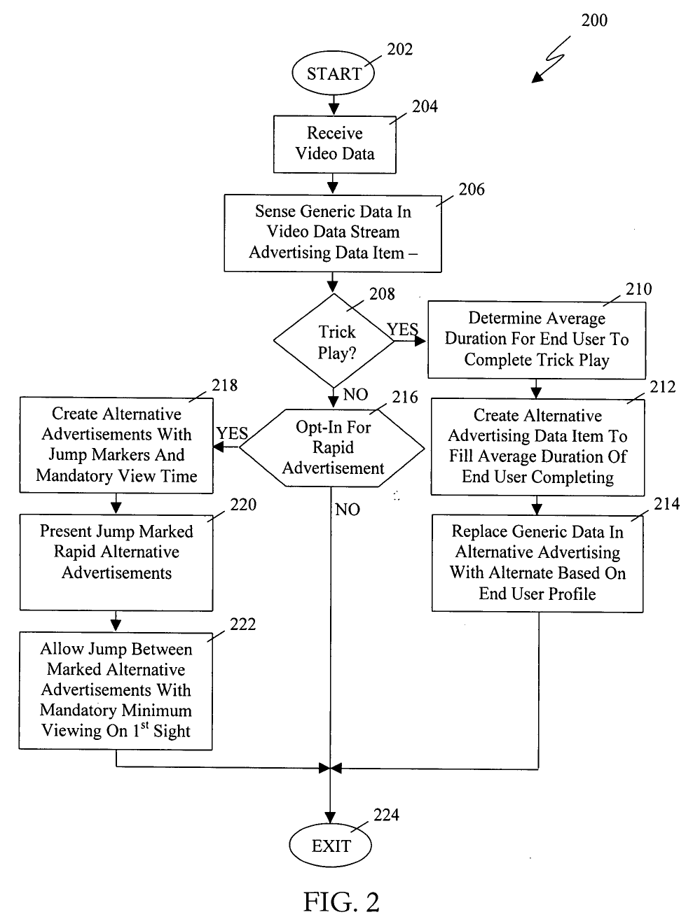

Turning now to FIG. 2 in an illustrative embodiment a series of functions performed by a software agent or component executed by an illustrative system processor are performed to present alternative advertising data items in place of primary advertising data items. The functions start at starting terminal 102. At block 204 the function receives a video data stream containing primary advertising data items. At block 206 a function senses generic data in the video data stream. A data type for the sensed generic data item is recorded in the data base or data structure embedded in computer readable memory. At block 208 a function determines if an end user has invoked at PVR trick play command. If a PVR trick play command has been invoked, at block 210 a function determines the average duration for the particular end user to complete the trick play command based on the duration of the advertising data items being skipped. A particular illustrative embodiment of a system and method monitor PVR trick play command execution and record historical data for PVR commands, including the average duration for PVR trick play commands for different durations of primary advertising data items. For example, historical data is recorded for the duration of an end user to fast forward through three minutes of advertising. End users who consistently fast forward through advertising are noted so that these end users become candidates for alternative rapid advertising, discussed below. For example, if an end user is fast forwarding past five 30 second commercials, a historical number is the user profile has been measured for the end user fast forwarding over five 30 second commercials and is used for create an alternative advertising data item having a duration equal to the average time taken for the end user to fast forward past five 30 second commercials.

If the specific average time is not available, duration can be estimated from another number in the historical end user profile. For example, an average time to fast forward past two 30 second commercials can be multiplied by 2.5 to arrive at an estimated aver time to fast forward past five 30 second commercials. In another particular embodiment an illustrative method and system determine a fast forward speed for a viewer watching a PVR stored video stream in fast forward at one of several fast forward speeds, for example, 2×, 4×, 8× and 16× times normal speed. In an illustrative embodiment, one of several available alternative audio tracks is played back depending on the fast forward speed. A separate audio track is stored for each fast forward playback speed and synchronized with the video frames in the video data stream. In another particular illustrative embodiment, the separate alternative audios tracks for each playback speed (2×, 4×, 8× and 16×) are included in MPEG user accessible meta data blocks of the incoming video data stream and stored for playback with the MPEG video at variable play back speeds.

For example, at block 212 a function creates an alternative advertising data item to fill the duration for the end user completing the trick play. At block 214 a function replaces the generic data with the alternative advertising data. The selection of alternative data for the replacement of the generic data can be informed by weights, demographics and location data in the end user profile. The function then proceeds to exit terminal 224.

In another particular embodiment, an end user who consistently skips all advertising can select an alternative rapid advertising option. The alternative rapid advertising option present short “rapid” advertisements which last only 15-20 seconds or less. The alternative rapid advertisements may have a minimum mandatory viewing period, discussed below. If there is no trick play invoked at block 208, a function at decision block 216 determines if the end user has opted-in for rapid advertisements. If the end user has opted in for alternative rapid advertisements, a function at block 218 creates alternative rapid advertisements and inserts advertising jump markers if jump is enabled and imposes a mandatory minimum viewing period for the first viewing instance of each rapid advertisement before allowing an end user to jump to another alternative rapid advertisement. If jump advertising is enabled for rapid advertising, at block 220 a function presents the jump marked alternative rapid advertisements. At block 222 a function allows an end user to jump between jump-marked alternative rapid advertisements after the alternative rapid advertisement has been presented for a minimum mandatory presentation time at the end user device. Thus, a user must view a jump-marked rapid advertisement for a minimum mandatory period, for example, 5 seconds before jumping to another alternative rapid advertisement.

Once a particular jump-marked alternative rapid advertising data item has been viewed for the mandatory minimum viewing time, the particular jump-marked alternative rapid advertising data can be redisplayed by jumping to it again, but the second time the particular jump-marked rapid advertisement is presented, there is no minimum mandatory presentation time, so that the second presentation can be aborted immediately to jump to another alternative advertising without waiting for the minimum mandatory presentation time to expire. The function then proceeds to exit terminal 224.

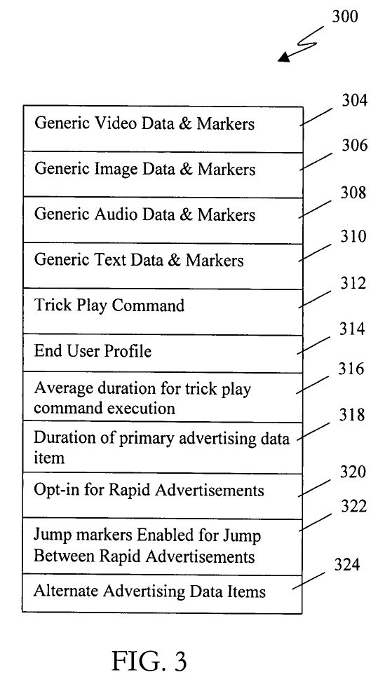

Turning now to FIG. 3 in a particular illustrative embodiment a data structure 300 embedded in a computer readable medium for providing a structural and functional interrelationship between the data in the data structure and a processor, processor software or method for presenting data related to a video data stream. The data structure 300 includes fields for storing data used by an illustrative embodiment of a system and method. In data structure field 302 a generic video data and generic video data markers data field is illustrated in which data is contained indicating a particular generic video data and generic video data markers, or a plurality of particular generic video data items for use by an UDSS or EUDSS in sensing generic video data and generic video markers that appear in the incoming television signal. In data structure field 304 a generic image data and markers field is illustrated for storing data indicating generic image data and generic image markers data. The generic image data and generic image data markers can be in form of a list of video generic images and markers for use by an UDSS or EUDSS in sensing image generic data and image generic markers that appear in the incoming television signal.

In data structure field 306 a generic audio data and markers field is illustrated for storing data indicating generic audio data and generic audio markers data. The generic audio and generic audio markers data can be in form of a list of generic audio data and generic audio data markers for use by an UDSS or EUDSS in sensing audio generic data and audio generic markers that appear in the incoming television signal. In data structure field 308 a generic text data and markers field is illustrated for storing data indicating generic text data and generic text markers data. The generic text data and generic text markers data can be in form of a list of generic text data and generic text data markers for use by an UDSS or EUDSS in sensing generic text data and generic text markers that appear in the incoming television signal.

In data structure field 310 a trick play command field is illustrated for storing data indicating a PVR trick play command currently invoked by an end user indicated in the end user profile. An illustrative system and method use the PVR trick play command data to create an appropriate alternative advertising data item having a duration equivalent to the duration of completing the trick play command. In data structure field 312 an end user profile field is illustrated for storing data indicating an end user profile. The viewer profile data includes but is not limited to data indicating demographic data, location or region data, interests data (sports, fashion), preference data (merchants used) and language spoken. In data structure field 313 a field is illustrated for storing data indicating an average duration for the trick play command execution for the PVR trick play command in data structure field 310 using historical data for PVR trick play commands executed by the end user indicated in the end user profile. In data structure field 314 a field is illustrated for storing data indicating duration of primary advertising data being replaced by alternative advertising data.

In data structure field 316 a field is illustrated for storing data indicating whether an end user has chosen to opt-in for alternative rapid advertising. In data structure field 318 a field is illustrated for storing data indicating jump markers for alternative advertisements for jumping between alternative rapid advertising data items. In data structure field 320 a field is illustrated for storing data indicating alternative advertising data items for presentation in place of primary advertising data items that appear in an incoming video signal such as an IPTV video data stream.

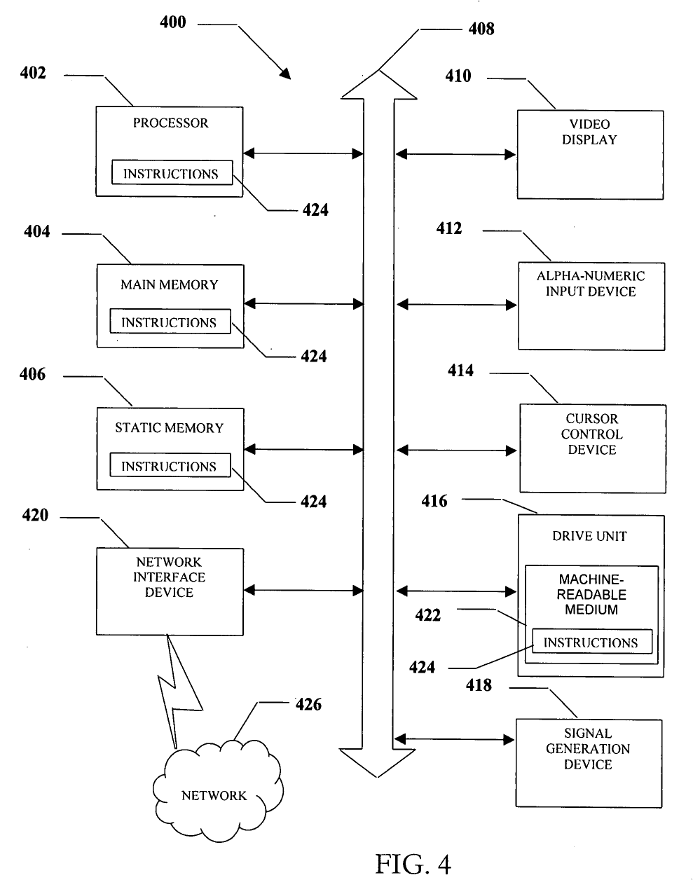

FIG. 4 is a diagrammatic representation of a machine in the form of a computer system 400 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine.

It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU), or both), a main memory 404 and a static memory 406, which communicate with each other via a bus 408. The computer system 400 may further include a video display unit 410 (e.g., liquid crystals display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface.

The disk drive unit 416 may include a machine-readable medium 422 on which is stored one or more sets of instructions (e.g., software 424) embodying any one or more of the methodologies or functions described herein, including those methods illustrated in herein above. The instructions 424 may also reside, completely or at least partially, within the main memory 404, the static memory 406, and/or within the processor 402 during execution thereof by the computer system 400. The main memory 404 and the processor 402 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420. The machine readable medium may also contain a data structure for containing data useful in providing a functional relationship between the data and a machine or computer in an illustrative embodiment of the disclosed system and method.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computerized method for replacing a primary advertising data item with an alternative advertising data item, the method comprising:
receiving a primary advertising data item in a video data stream;
replacing a generic data subset of the primary advertising data item with alternative data to create the alternative advertising data item; and
sending the alternative advertising data item to an end user device for presentation of the alternative advertising data item in place of the primary advertising data item upon occurrence of an end user event.

2. The method of claim 1, wherein the video data stream comes from an internet protocol television (IPTV) system, the method further comprising:
sensing the generic data in the primary advertising data item; and
marking the generic data in the primary advertising data item.

3. The method of claim 1, wherein the end user event is a personal video recorder trick play command selected from the group consisting of fast forward and commercial skipping.

4. The method of claim 3, wherein the generic data further comprises generic audio key words provided by an IPTV advertising server and the alternative data item further comprises alternative audio words provided by the IPTV advertising server.

5. The method of claim 1, wherein the generic data is of a first data type selected from the group consisting of audio, video, text and image data and the alternative data further is of a data type selected from the group consisting of audio, video, text and image data, wherein the generic data of the first data type is replaced by the alternative data of the first data type.

6. The method of claim 1, wherein sensing the generic data further comprises sensing a generic data marker in the primary advertising data item, wherein the generic data marker is inserted by an upstream data sensing system at a server in the IPTV system.

7. The method of claim 1, wherein the generic data is sensed at an IPTV server by an upstream data sensing system and the generic data is replaced with the alternative data at an end user device by an end user data sensing system.

8. The method of claim 1, wherein the alternative data further comprises a plurality of alternative data items for each of a plurality of generic data wherein one of the plurality of choices of alternative data items is selected for replacing the generic data based on an end user profile.

9. The method of claim 1, wherein the end user event comprises skipping from a first primary advertising data item to a second primary advertising data item in the video data stream.

10. The method of claim 2, wherein duration for the alternative advertising item is based on an average duration of completing the trick play command by the end user for duration of the primary advertising data item, based on an end user profile for the end user.

11. The method of claim 1, wherein duration of the alternative advertising data item is based on duration of the primary advertising data item and end user opt-in data in an end user profile for the end user, wherein the opt-in data indicates that the end user is presented the alternative advertising data item.

12. The method of claim 1, wherein the alternative advertising data item further comprises a plurality of alternative advertising data items, wherein an end user skips forward and backward between each of the plurality of alternative advertising data items upon the presentation at the end user device.

13. A system for presenting an alternative advertising data item, the system comprising:
a computer program comprising computer instructions stored in a computer readable medium; and
a processor in data communication with the computer readable medium for executing the computer instructions, the processor further comprising,
a first interface for receiving a primary advertising data item in a video data stream, a second interface for receiving a generic data subset of the primary advertising data item, the computer program further comprising instructions to replace the generic data in the primary advertising data item with alternative data to create an alternative advertising data item and instructions to send the alternative advertising data item to an end user device for presenting the alternative advertising data item in place of the primary advertising data item upon occurrence of an end user event.

14. The system of claim 13, wherein the video data stream comes from an internet protocol television (IPTV) system, the computer program further comprises instructions to sense the generic data in the primary advertising data item; and instruction to mark the generic data in the primary advertising data item.

15. The system of claim 14, wherein the end user event is a personal video recorder trick play command selected from the group consisting of fast forward and commercial skipping.

16. The system of claim 13, wherein the generic data further comprises generic audio key words provided by an IPTV advertising server and the alternative data item further comprises alternative audio words provided by the IPTV advertising server, wherein a generic audio word is replaced by an alternative audio word based on an end user profile.

17. The system of claim 13, wherein the end user event is a personal video recorder trick play command selected from the group consisting of fast forward and commercial skipping.

18. The system of claim 13, wherein duration for the alternative advertising item is based on an average duration of completing the trick play command by the end user for duration of the primary advertising data item based on an end user profile for the end user.

19. The system of claim 13, wherein the alternative advertising data item further comprises a plurality of alternative advertising data items, wherein an end user skips forward and backward between each of the plurality of alternative advertising data items, upon presentation at the end user device.

20. A computer readable medium having stored therein a computer program, the computer program comprising computer instructions useful for presenting an alternative advertising data item in place of a primary advertising data item, the computer program comprising:
instructions to receive the primary advertising data item in a video data stream in an internet protocol television (IPTV) system;
instructions to receive generic data for sensing the generic data as a subset of the primary advertising data item;
instructions to sense the generic data as a subset of the primary advertising data item; instructions to replace the generic data in the primary advertising data item with alternative data to create the alternative advertising data item;
and instructions to send the alternative advertising data item to an end user device display for presenting the alternative advertising data item in place of the primary advertising data item upon occurrence of an end user event.

21. The medium of claim 20, wherein the generic data is of a first data type selected from the group consisting of audio, video, text and image data and the alternative data further is of a data type selected from the group consisting of audio, video, text and image data, wherein the generic data of the first data type is replaced by the alternative data of the first data type.

22. A computer readable medium having a data structure embedded thereon, the data structure comprising:
a first field for storing data indicating generic advertising data for sensing in a subset of the primary advertising data item; and
a second field for storing data indicating a plurality alternative audio advertising data words for replacing the audio key word generic data in the primary advertising data item based on an end user profile.

23. The medium of claim 22, wherein the end user profile contains data selected from the group consisting of location data and demographic data for use in selecting one of the plurality of alternative audio advertising data words for replacing the audio key word generic data.

24. The computer readable medium of claim 23, the data structure further comprising:
a third field for storing data indicating markers for the generic data for use in replacing the generic data.

25. The computer readable medium of claim 22, the data structure further comprising:
a fourth field for storing data indicating an average duration for an end user to complete a trick play command for duration of the primary advertising data item.

26. The computer readable medium of claim 25, the data structure further comprising:
a fifth field for storing data indicating alternative advertising data items for replacement of primary advertising data items for the duration of the average duration.

27. The computer readable medium of claim 26, the data structure further comprising:
a sixth field for storing data indicating an opt-in for presentation of alternative rapid advertising data.
